(19) United States
(12) Patent Application Publication
(10) Pub. No.: US 2006/0010249 A1
(43) Pub. Date: Jan. 12, 2006

(54) Restricted dissemination of topology information in a communication network

(76) Inventors: Subramaniam Sabesan, Bishops Stortford (GB); Martin Biddiscombe, Harlow (GB); Glenn Denney, Knebworth (GB)

Correspondence Address: BARNES & THORNBURG, LLP, P.O. BOX 2786, CHICAGO, IL, 60690-2786, US

(21) Appl. No.: 10/975,067

(22) Filed: Oct. 13, 2004

(30) Foreign Application Priority Data
Jun. 9, 2004 (GB) 0412847.6

(51) Int. Cl. G06F 15/16

(52) U.S. Cl. 709/238

(57) ABSTRACT

A communication network comprises a plurality of nodes interconnected by communication links. A node maintains a database of topology information relating to the network. A node receives a topology advertisement from another node of the network which provides information about a part of the network. The topology advertisement includes a metric which is related to aggregate distance or cost of the path travelled by the topology advertisement. The node compares the metric in the newly received topology advertisement with one previously received for the same part of the network. The database is updated with the newly received topology advertisement if the value of the metric in the newly received topology advertisement is lower than the metric in the topology advertisement previously received for the same part of the network. The method can be used during flooding or database synchronisation. The metric can be carried within a header or body of a topology advertisement, such as a Link State Advertisement (LSA).

### FIELD OF THE INVENTION

This invention relates to the dissemination of topology information in communication networks.

### BACKGROUND TO THE INVENTION

Communication networks comprise a large number of interconnected network nodes, such as terminals, routers and switches. Data is communicated through such a network by passing protocol data units, such as Internet Protocol (IP) packets, Ethernet frames or data cells between nodes. A particular protocol data unit may travel along a path through many such nodes and communication links and a network of this kind should efficiently route the protocol data units between nodes.

In-order to route packets, the network topology needs to be known by all nodes in the network. Network topology information, which can be used to route data units, can be exchanged between nodes using a variety of protocols. With link state routing protocols each router advertises information about links to which it is connected and update messages known as Link State Advertisements (LSAs) are sent between routers. Link State routers maintain topology databases containing representations of every link and router in the network and a state for each element. One link state protocol is Open Shortest Path First (OSPF), which is described in RFC2328. Routing protocols such as OSPF work well in small networks but they are less suited to larger networks, and networks where the topology changes frequently. One situation where the network topology can frequently change is in wireless ad-hoc networks. The topology may change quite often, and even if nodes are not being added, removed or moved transient radio interference will cause links between nodes to vary in both their capacity and their availability. The cost, in terms of bandwidth, of updating each node's view of the network topology is high. If the number of network nodes is large or the topology is changing, for example due to wireless links forming and breaking as radio reception quality varies, the number of updates required will be large, resulting in significant bandwidth consumption by the routing protocol.

One known way of coping with this problem is to divide OSPF routers into areas. Routers within each area are only configured with information about other routers within their own area. Special routers, known as border routers, interwork between areas. While this scheme can reduce the number of link state advertisements that are sent between nodes this kind of sub-division requires a centralized management function. This requirement does not lend itself to ad-hoc networks, where it is desirable that nodes should not require centralized management or configuration.

A U.S. Patent Application with U.S. Ser. No. 10/757,139, filed 14 Jan. 2004, the contents of which are incorporated herein by reference, describes how link state advertisement messages are propagated a limited distance from their source. This creates the notion of a routing radius, which is defined for each node and includes the nodes whose distance is no more than some predefined limit. With this enhancement to OSPF, each node will only know the topology of the network within its routing radius and nodes are updated about topological changes only within that radius. Thus, even though a network can be arbitrarily large, the updates are only propagated relatively locally.

The present invention seeks to improve the operation of a network in which routing information is propagated within a restricted radius from each node.

### SUMMARY OF THE INVENTION

A first aspect of the present invention provides a method of processing topology information at a node within a communication network, the network comprising a plurality of nodes interconnected by communication links, the node comprising a database of topology information relating to the network, the method comprising:
receiving a topology advertisement from another node of the network which provides information about a part of the network;
comparing a metric within the newly received topology advertisement which is related to aggregate distance or cost of the path travelled by the topology advertisement with the metric of a topology advertisement previously received for the same part of the network; and,
updating the database with the newly received topology advertisement if the value of the metric in the newly received topology advertisement is lower than the metric in the topology advertisement previously received for the same part of the network.

The node does not automatically refuse a new topology advertisement advertising a part of the network (such as a link) that the node already knows about as the new topology advertisement may, under some circumstances, have travelled a shorter path. In this way the node can maintain a full database of topology information, and other nodes can also receive routing information which they may not have otherwise received.

Further aspects of the invention relate to a node including control logic which is operable to perform any of the steps of this method and a network incorporating such a node.

Although in this application a wireless-based network will be described, and the nodes will be discussed as communicating with each other and with end users using various wireless protocols, the invention is not limited in this regard. Rather, the invention may be used more broadly with other types of communication technology, such as wireline, infra red, acoustic, and numerous other types of communication technology.

The functionality described here can be implemented in software, hardware or a combination of these. The invention can be implemented by means of hardware comprising several distinct elements, and by means of a suitably programmed computer. Accordingly, another aspect of the invention provides software for performing any of the steps of the method. It will be appreciated that software may be installed on the node at any point during the life of the equipment. The software may be stored on an electronic memory device, hard disk, optical disk or other machine-readable storage medium. The software may be delivered as a computer program product on a machine-readable carrier or it may be downloaded directly to the node via a network connection.

In the following description embodiments are described with reference to the link state protocol Open Shortest Path First (OSPF). However, the invention is not limited to OSPF and is applicable to other routing protocols such as Intermediate System to Intermediate System (IS-IS). The term ‘topology advertisement’ is to be construed as a message which provides information about the topology of a part of the network, and can include information about the existence and/or state of a link within a network. In a preferred embodiment, the topology advertisement is a link state advertisement such as the Link State Advertisement (LSA) used in OSPF.

### BRIEF DESCRIPTION OF THE DRAWINGS

Embodiments of the invention will be described with reference to the accompanying drawings in which:

FIG. 1 shows a communications network in which link state advertisements are forwarded for a restricted distance;

FIG. 2 shows how a node advertises links to other nodes;

FIG. 3 shows a conventional LSA header;

FIG. 4 shows a modified LSA header carrying an aggregate metric;

FIG. 5 shows a conventional LSA message;

FIG. 6 shows a modified LSA message carrying an aggregate metric;

FIG. 7 shows the process of flooding link state advertisements between nodes;

FIG. 8 shows the process of synchronising databases at a pair of nodes;

FIGS. 9 and 10 show a synchronising operation between a group of nodes;

FIG. 11 shows an example communications network in which the invention can be applied;

FIG. 12 shows a block diagram of the functions within a node of the network of FIGS. 1 and 11.

### DESCRIPTION OF PREFERRED EMBODIMENTS

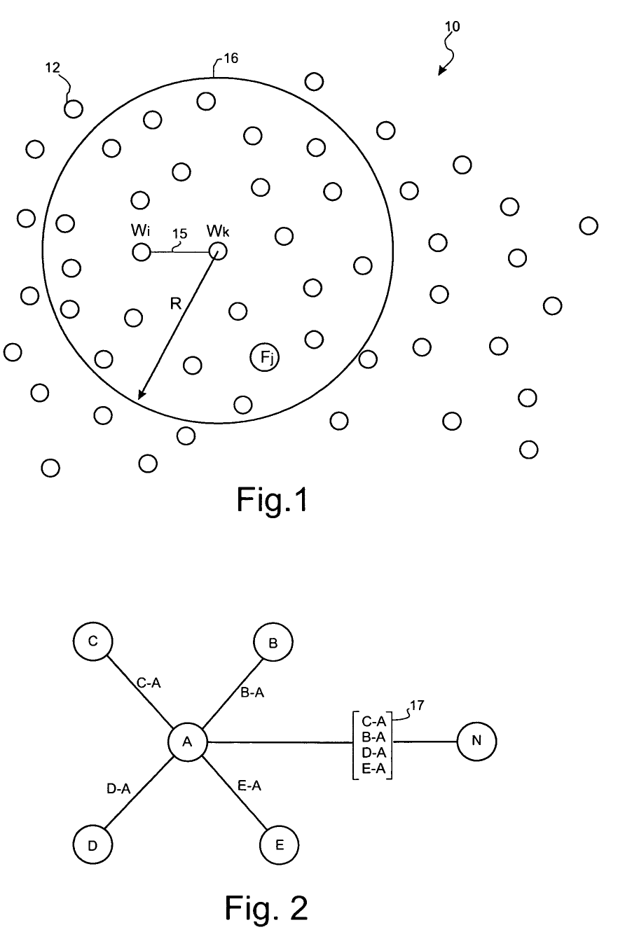

FIG. 1 illustrates an example of a communication network 10 in which the invention can be applied. A plurality of nodes 12 are shown distributed across an area. Neighbouring nodes are interconnected by communication links to form an interconnected mesh topology. For clarity, only one such link 15 is shown between a pair of nodes Wi, Wk. In accordance with the standard features of the OSPF protocol (RFC 2328) the details of link 15 will be advertised in a Link State Advertisement (LSA) message to all others nodes in the network 10, which results in a significant volume of LSA messages. When a LSA is created at a node, it is broadcasted on all of the interfaces (to links) at that node. When a node receives a LSA, it processes the LSA and floods it to all of the neighbouring nodes other than the neighbouring node from which the LSA was received. These updates are generated at regular intervals to prevent the network information from becoming ‘stale’ and timing out. LSAs can be transmitted in response to a node detecting a change in the state of a link. The forwarding process results, over a period of time, in all nodes 12 within the network 10 being informed of a link, or of a change to a link. Once an LSA reaches its maximum age, and if a more recent update has not been received, the nodes holding that LSA in their database are required to delete it and no longer use it for routing purposes.

A further updating process is known as synchronisation. Each router maintains a database description of the network topology and each router has an identical topology database. The database is a particular router's local state and the router shares its local state with the rest of the network. OSPF routers keep their topology databases synchronised by exchanging information is through database synchronisation at node start-up. During this process, each of the new node's neighbours updates it with the latest topology information they have.

FIG. 2 shows a very simplified set of nodes. Node A is connected to neighbouring nodes B, C, D, E by respective links. Node A originates a link state advertisement 17 which contains information about links B-A, C-A, D-A, and E-A.

In accordance with an embodiment of the invention, the propagation of LSAs during flooding and synchronisation is bounded without requiring distinct OSPF areas to be defined. As shown in FIG. 1, advertisement of the link 15 between nodes Wi and Wk will propagate a particular distance R on the network and then not propagate any further. The approximate total propagation area for the LSA associated with link 15 is shown by the circle 16. Referring again to FIG. 2, the LSA 17 is forwarded by several nodes and arrives at a distant node N. Node N will need to determine if the LSA should continue to be advertised on the network or dropped, and whether the information contained in the LSA should be included in its routing tables. This decision is required for both LSA flooding and database synchronization in OSPF. By limiting the distance a Link State Advertisement (LSA) will propagate on the network it is possible to limit LSA traffic on the network without defining ‘hard’ areas on the network. Not having areas on the network eliminates the need to name those areas and designate nodes as belonging to particular areas. This enables new nodes to be added to the network on an ad-hoc basis without a centralized management structure. Additionally, this enables the nodes to be mobile on the network without requiring close monitoring and updating of area affiliation by the nodes. Further, not having areas on the network eliminates the requirement for area border routers to control link state advertisements, reduces or eliminates special intra-area communication protocol exchanges, and avoids potential congestion which may occur in connection with inter-area traffic.

In order to limit the propagation of LSAs beyond the radius limit, when an LSA arrives at a router—either as part of the database synchronisation phase, or during update flooding—the router must decide whether or not to install the LSA, and therefore also whether or not to propagate the LSA further, based on the distance to the LSA's point of origin. Conventional OSPF (RFC2328) does not provide any indication of how far an LSA has travelled. Also, a node does not know explicitly (except at steady state, when it is able to look up the originating node in its routing table) how far away the source of such a protocol data unit (PDU) is from itself. Therefore, in order to restrict the flooding, a method of determining the distance of the origin of a PDU has to be introduced. This could be achieved in various ways. Two possible ways are:

1. Carry a metric within the LSA (either within the header or body of the LSA) and update this metric as the LSA passes through nodes. The metric is representative of the aggregate cost of the path travelled by that LSA. The cost can be expressed in terms of distance, resources or another quantity. The metric is incremented by a node as the LSA propagates through the network. Each node maintains a threshold value for the metric. LSAs which carry a metric which falls below the threshold value are propagated to other nodes, while LSAs which carry a metric which is above the threshold value fall are not propagated any further.

2. Delay the forwarding (flooding) of incoming LSAs until the router knows the distance to the source. This requires the router to wait until shortest path first (SPF) calculations have been made which, in turn, requires the router to have received LSAs from all other nodes. This will cause significant delay and computational overhead. In addition, during the initial database synchronisation phase when an OSPF router comes online and learns the network topology from its neighbours, the order it receives LSAs is nearly always unrelated to the network topology. It is entirely possible that the router may receive many LSAs (possibly dozens or hundreds) before it is able to build a shortest path first tree with itself as the root. The reason for this is that it may not receive the LSAs describing its immediate neighbours, or their neighbours until late on in the synchronisation process.

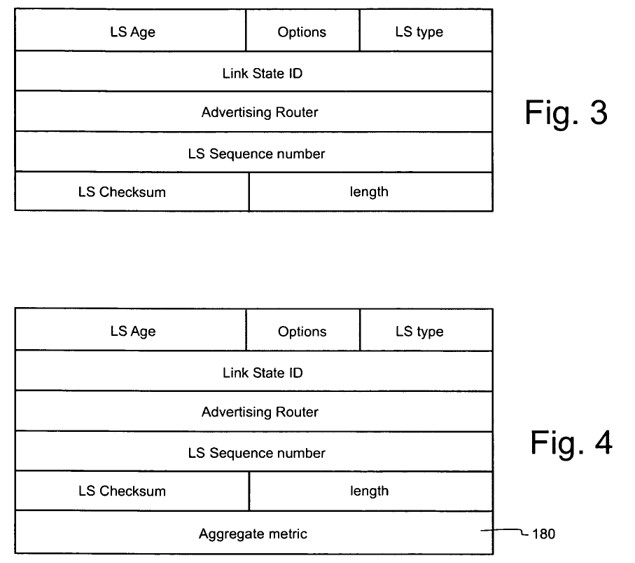

In view of the above, it is preferred to carry the aggregate cost metric within the LSA. The aggregate metric can be carried within the header of a LSA or within the body of the LSA. FIG. 3 shows a standard OSPF header and FIG. 4 shows a modified OSPF header with a new field 180 appended to the end. There is a significant benefit in carrying the extra information within the header because during database synchronisation only the headers are exchanged between neighbouring routers to determine the missing topology information at each router. If the radius information is readily available within the header then this will reduce the complexity of introducing the radius restriction at synchronisation. However, as there are no spare bits within a LSA header the extra field 180 must be added to the header to carry the aggregate metric information. A 4 byte wide field (32 bit unsigned integer) can carry the aggregate metric. Changing the size of the LSA header would require changes to OSPF apparatus to accommodate the exchange of this extra information.

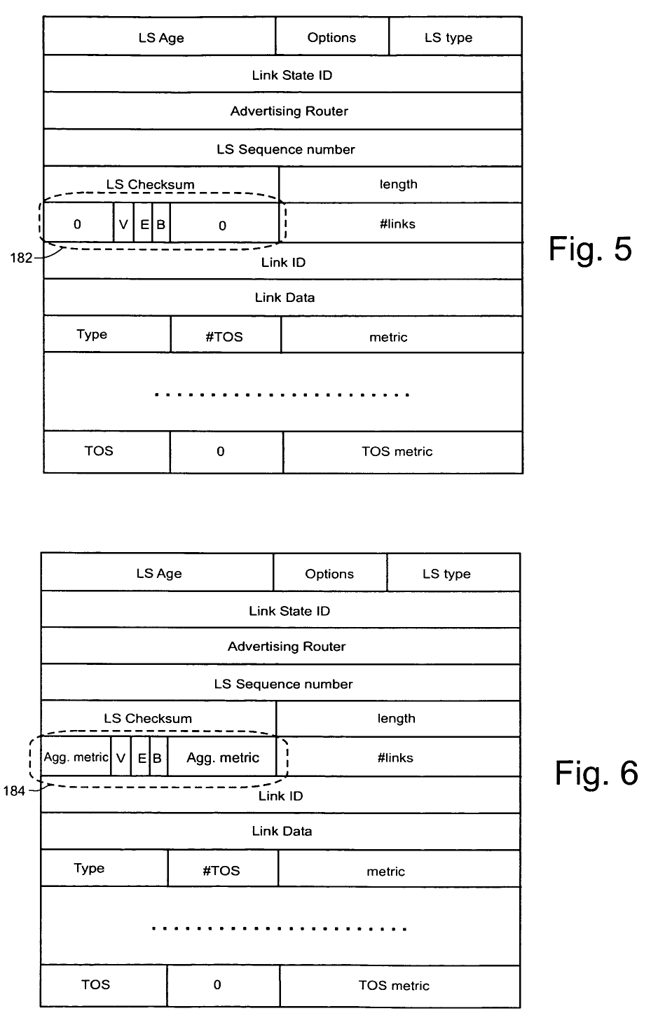

Alternatively, it is possible to carry the aggregate metric in the body of router LSAs, since there are some unused bits available. FIG. 5 shows a standard OSPF LSA. At the start of the body there are 2 bytes allocated as “flags field” 182 and only 3 bits (V,E,B bits) within this two byte field are used. As shown in the modified LSA of FIG. 6, the remaining 13 unused bits of the modified flags field 184 are used to carry the aggregate metric. Doing so has no impact on the length of the LSA and hence the enhancements required to incorporate these changes should not impact the majority of existing LSA handling procedures. However, as described below, some changes need to be made to the synchronisation process due to the unavailability of the aggregate metric within the LSA header.

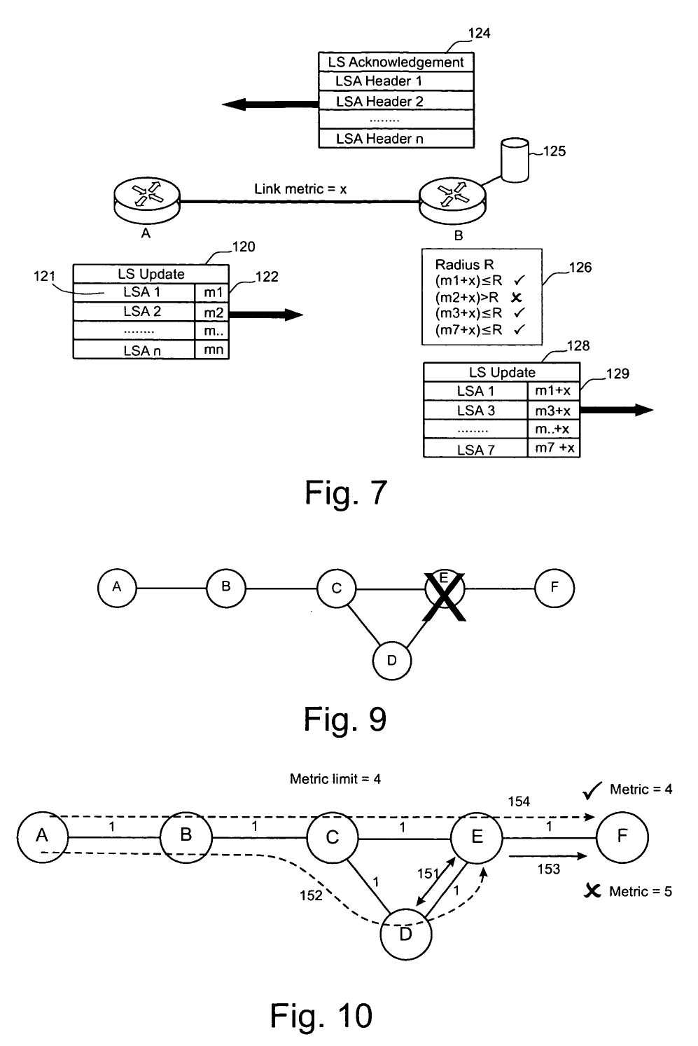

FIG. 7 outlines the process of handling LSAs with a network in accordance with an embodiment of the invention. Two nodes—node A and node B are shown. Node A sends a link state update 120 to node B which includes one or more LSAs 121. The LSAs each relate to a link within the network. Each LSA has a metric value 122 associated with it which is indicative of the aggregate cost of the path travelled by that LSA. When node B receives a router LSA, in addition to the standard OSPF LSA handling procedures the node must do the following:
Validate the Checksum. A checksum calculation is performed on the contents of the LSA and compared to the checksum field carried within the LSA. The aggregate metric field is replaced with zeros during checksum calculations so that the additional metric information added to the LSA does not affect the checksum value. The checksum value is used as part of the ‘which LSA instance is newer’ tiebreak (RFC 2328 section 13.1) and it is undesirable to cause this mechanism to fail. Also, when acknowledging receipt of an LSA, the received LSA header is used as part of the acknowledgement.
Increment the metric. Node B adds the incoming link's metric cost (in this case the cost of link A−B=x) to the aggregate metric. This updates the aggregate metric value as the LSA passes through the nodes. When LSAs are originated at a node, the initial value of the aggregate metric is zero.
Radius check. Node B compares, for each LSA within the update, the newly incremented aggregate metric value associated with that LSA with a threshold metric value representing the maximum propagation radius. Depending on the comparison, node B acts as follows:
a. If the aggregate metric is less than or equal to its threshold value then it accepts the LSA and then the normal LSA handling procedures are followed as standard, including installation of the LSA in it's local database 125, advertising of the LSA during database synchronisation and onward flooding 128 of the LSA.
b. If the aggregate metric is greater than the radius limit then it discards the LSA and the normal OSPF procedures are followed as standard. However, the node has to acknowledge 124 receipt of this LSA before discarding to prevent any further transmission of this LSA by its neighbours.
   As shown in FIG. 7, all LSAs within the update 120 are acknowledged by a LS Acknowledgement message 124. In this example LSAs 1, 3 and 7 are deemed to fall within the metric threshold. Thus, node B sends a LS Update message 128 to neighboring nodes which includes LSAs 1, 3 and 7. Each LSA carries a metric with the newly incremented metric value 129.

Database Synchronisation

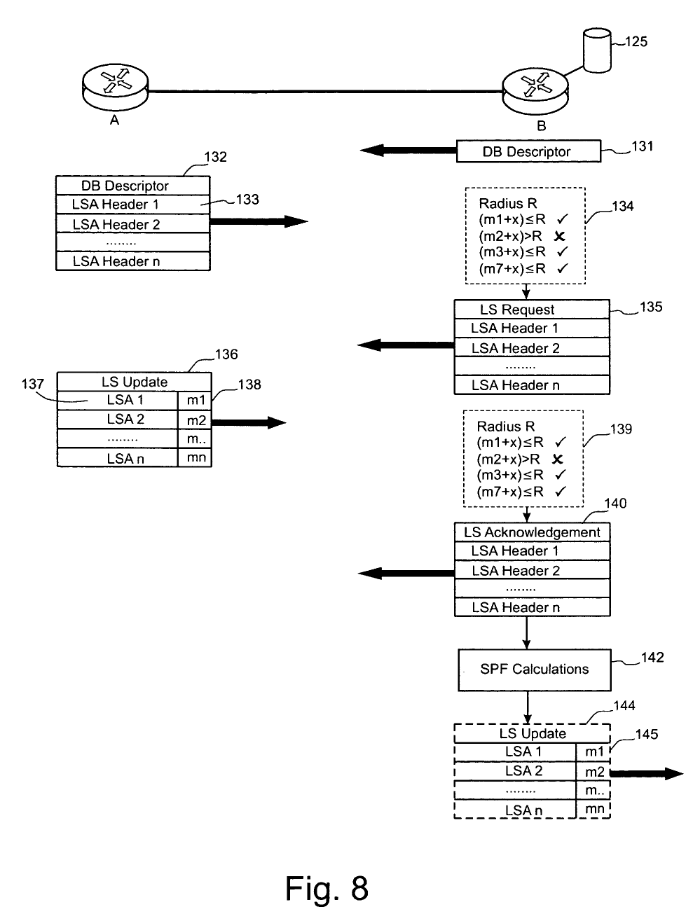

At start-up a router goes through a database synchronisation phase before it becomes fully adjacent to its neighbours, which is summarised in FIG. 8. Router B is the router requiring topology information, e.g. as a result of just being brought into service. Initially, router B exchanges ‘hello’ messages with neighbouring routers on all links. After the ‘hello’ exchange, router B and its neighbours will exchange DB Descriptor messages, which include message 131 sent from router B and the reply 132 sent from router A. Initially, the link state database 125 of router B will contain no network information apart from information about the local links at router B. The DB Descriptor message 132 summarises the LSAs that router A is aware of in the form of a list of LSA headers 133. Router B checks its database 125 against the received descriptor 132. The LSA headers in the descriptor message are compared to those of the LSAs in the database 125. If the database descriptor 132 contains headers 133 representing LSAs not present in node B's topology database 125, or newer versions of known LSAs, node B requests that those LSAs be sent to it by sensing a LS Request message 135. When a router receives an LSA request 135 it sends the full LSA to node B in message 136. As previously described with reference to FIG. 7, each LSA has a metric value associated with it which is indicative of the path travelled by that LSA. Receipt of the LSAs is acknowledged by sending a LS Acknowledgement message 140. At the end of this phase, when all pairs of neighbouring routers have synchronised with one another, all the routers have the same topology information. In order to implement the radius restriction during the database synchronisation, nodes should either not advertise, or not request, LSAs that have reached their radius limit. If the aggregate metric is carried as part of the header of a LSA, then node B can readily determine whether a LSA should be requested or not at step 134 in response to receiving LSA headers 133 within the DB descriptor 132. However, if the aggregate metric is carried within the body of a LSA, the metric information is not readily available at step 134. During database synchronisation, only LSA headers are exchanged, and these do not contain sufficient information to determine the distance to the point of origin of the original LSA they represent. Therefore, a node cannot modify the creation of LSA requests in order to ask for only the LSAs that are within their propagation radius. However, once a node has received a LSA, it will be in a position to determine, or at least to calculate an upper bound on, the distance to its point of origin. Having done this, the node should not install those LSAs that have exceeded their propagation radius. Doing this will also prevent LSAs that have exceeded their propagation radius being advertised in the node's own database descriptor messages.

If the aggregate metric is carried as part of the header, then radius restriction can be performed at step 134 of the synchronisation process to filter LSAs that are within its radius. When an LSA arrives and the node decides to drop it due to the radius restriction, it needs to clear that LSA from the “missing LSAs list” (created by the synchronisation procedure to request missing LSAs) which is used to compile the LS Request message 135. This prevents the node from repeatedly requesting the missing LSAs from its neighbours, the neighbour sending those LSAs and the node dropping the LSAs, which prevents the node from forming a full adjacency.

FIGS. 9 and 10 illustrate one of the interesting behaviours that can occur when the propagation radius is restricted and standard OSPF techniques are followed at network nodes. FIG. 9 shows a network of interconnected nodes A-F. Initially, in FIG. 9, node E is out of service. When node E returns to service, as shown in FIG. 10, it runs through a database synchronisation phase with all of its neighbours (i.e. nodes C, D & F). It will be assumed that node E first synchronises with router D at step 151. For simplicity, it is assumed that the link metrics are all 1 unit and the metric limit for radius restriction is set at 4. The aggregate metric for an LSA originating at node A when received at C is 2. Similarly, the aggregate metric for an LSA originating at A when received at D is 3. When router E receives the LSA from A via D at synchronisation (shown as path 152), it checks whether the metric limit has been exceeded. The LSA received via path 152 has a metric value of 4 when received at node E. Node E accepts this LSA because it is within the metric limit of 4. Node E proceeds to forward the LSA to neighbouring node F. When the LSA originating at A is advertised by router E to router F (shown as message 153), router F does not install it, because by then the aggregate metric has been increased to 5, which exceeds the metric limit of 4. At some subsequent time, router E also synchronises with router C and compares the database descriptor list sent by node C with its own database to check for missing LSAs. However, since the LSA from router A is already in router E's database, it does not ask for that LSA from router C. Therefore, even though the aggregate metric would be smaller for the LSA from A via C, router E does not receive that information. If router E were to request and install the LSA which had travelled the shorter path, and if it also passed it on to router F (shown as path 154), then router F would learn that the aggregate metric for the LSA from router A actually had a value=4 and thus is still within its propagation radius. The same problem can also occur during LSA flooding. An LSA from router A could reach router E via D before an LSA which reaches router E via C. Therefore, the following changes, in addition to the basic changes described above, it is preferred that several further modifications are made to ensure radius-restricted OSPF functions as intended.

Firstly, the tiebreak algorithm is modified. The tiebreak process is described at section 13.1 “Determining which LSA is newer” of RFC 2328. Conventionally, the OSPF protocol compares a sequence number field within two LSAs to determine which is newer. The checksum can also be used if both LSAs have equal sequence numbers. The tiebreak process is modified so that the LSA with the smaller aggregate metric is considered as more recent. This enables the node to keep its database with LSAs received via the shortest paths and also enables the node to flood the least cost LSAs to its neighbours. This guarantees that LSAs will propagate the full distance to their radius limit. Referring back to the situation shown in FIG. 10, node E would receive and accept the apparent duplicate LSA received from node A via node C as it has a lower metric than the LSA received via path 152 and forwards this to node F. Thus, node F will now receive the LSA from A.

In addition to the above, when a router is able to look up a node in its routing table, it updates the aggregate metric value if the value is less than the current aggregate metric value. This enables the aggregate metric values to converge rapidly towards the shortest path metric-cost. The updating of an aggregate metric value within the DB automatically triggers an advertisement of those updated LSAs to neighbouring nodes.

Implementing these changes ensures that, in the steady-state, the radius restriction operates as expected. However, these changes are insufficient on their own to solve the problem of the over-restricted radius during the database synchronisation phase. To solve that, further changes are required. Two approaches can be taken.

A first approach is as follows. At synchronisation, even if a node has a router LSA within its database from one of its neighbours, request it again if it is offered from another neighbour, and rely on the enhanced tiebreak algorithm (described above) to accept the LSA only if it truly is more recent, or has travelled a shorter distance (has a lower aggregate metric). Referring again to FIG. 8, at step 135 the LS Request 135 includes an LSA that is already installed in database 125. When the further LSA is received, the modified tiebreak algorithm will decide which version to store, and effectively treats the same LSA with a lower aggregate metric as if it was more recent. This enables a router to update the database with the LSAs that actually travelled to it along the (or a) least cost path. This can result in increased traffic on the network as routers learn about the whole network on all their interfaces separately rather than only learning about the whole network once as parts of the picture are supplied by LSAs received on different interfaces.

Conventionally, at synchronization, the router will receive DB descriptor messages from all of its immediate neighbours. The router only asks a neighbour for missing LSAs and if it receives the LSA it will not ask the same one from another neighbour so that it only needs to obtain a copy of the LSA from one neighbour and not from all neighbours. With the improvement described above, the router will ask for LSAs from the neighbours even if it has the same LSAs, thereby receiving the same LSA from all of its neighbours (providing they are offered by all the neighbours), thereby increasing the traffic during synchronisation. However, as routers discard LSAs that have propagated beyond their radius limit, this curbs the amount of extra traffic that would be generated.

A second approach is as follows. Referring to FIG. 8, after the synchronisation process (carried out as normal, possibly resulting in an incomplete picture) and after the SPF calculation 142 has been computed, the router checks its LSA database 125. If the distance to the origin of an LSA as calculated by the SPF 142 is shorter than the aggregate metric recorded within the LSA in its database, then the router updates the aggregate metric field 145 within the LSAs with the SPF-calculated cost and floods these modified LSAs to its neighbours (as if they were more recent updates) as step 144. This enables the neighbours to be updated with this information so that they in turn can make the radius decision based on the shortest path info. Nodes which erroneously fail to learn about some other nodes during the synchronisation phase (such as router F in the FIG. 10 example) will learn about them when these LSA updates are sent. This method also increases the network traffic, but it is anticipated that this will be smaller than in the first method. Once the database at each router have converged and stabilised, and the regular flooded updates are being propagated, this mechanism does not need to operate because the ‘true’ cost to each origin is already known from the existing SPF calculations and the on-the-fly updating of the aggregate metric in the LSA updates as performed by the second additional change to OSPF described above.

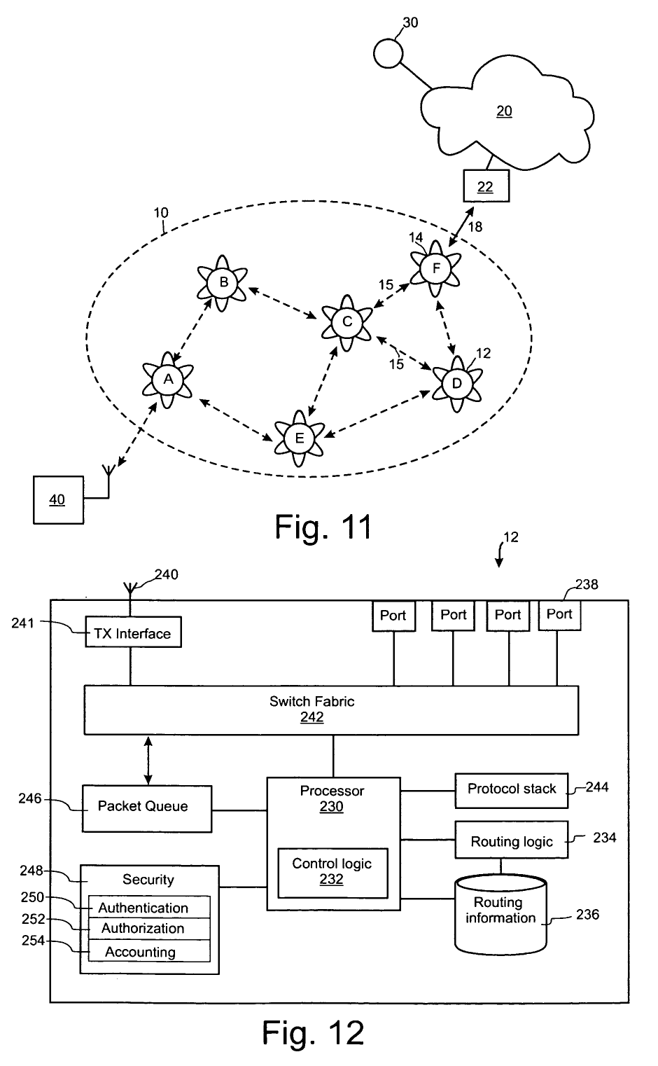

It will be appreciated that the invention described herein can be applied to many types of network and FIG. 11 shows one example of a communication network in which the invention may be applied. Some networks are arranged such that traffic is focussed towards a particular node in the network. This node, which will be called a focal node, may provide access to a backbone network. Most, or all, traffic within the network will pass to or from the focal node. In FIG. 11 a focal node 14 is connected by communication links 15 to other nodes 12 within domain 10. The nodes 12 are connected to each other by links 15 to form a mesh within domain 10, although the invention is not limited to a mesh topology. The focal node 14 is connected by relatively higher bandwidth resources 18, such as a wired link, to a packet gateway 22. The packet gateway 22 is connected to a high speed communication resource 20 such as the Internet or Public Switched Telephone Network (PSTN). Many such domains 15 can be provided in the same manner, each having a similar focal node 14 and a set of nodes 10. Traffic can be routed from one domain 10 to another via the network 20, or to remote servers 30 also connected to network 20. Focal node F may be considered a node within the domain 10 or may be considered a node on the border of the domain 10, as shown. In the example illustrated in FIG. 1, there is one focal node in domain 10, although the invention is not limited to this particular example. Referring back to FIG. 1, the radius R that LSAs propagate can be fixed in advance at a value that is intended to be sufficient to enable the link state advertisements to reach the focal node (and conversely for the link state advertisements to reach the nodes). If the network has a plurality of focal nodes, then the value of R should preferably be chosen so that LSAs can reach at least two of the focal nodes.

The nodes 12 in the domain 10 may communicate between each other using one wireless technology and may communicate with end users, such as a wireless terminal 40, using another wireless technology. These wireless technologies may be distinguished by frequency or protocol. In one implementation, the wireless technologies are IEEE 802.11a and IEE 802.11b although one of the IEEE 802.16x protocols, the Universal Mobile Telecommunication System (UMTS) wireless communications protocol, the IEEE 802.11a wireless communication protocol, IEEE 802.11g standard, HiperLAN, Bluetooth. or other emerging protocols such as IEEE 802.18 could also be used. The user terminal 40 can be a mobile telephone, a data terminal such as a laptop or personal digital assistant (PDA) or any other kind of communications device.

FIG. 12 is a functional block diagram of a node configured to implement an embodiment of the invention. The node 12 generally includes a processor 230 containing control logic 232 configured to perform functions described to enable the node to perform routing. The processor 230 may interface routing software 134 and routing tables 236 to enable it to perform the functions described above. The network element may be provided with one or more components (hardware and/or software) to enable it to communicate on a communication network. The node includes a plurality of network ports 238 as well as a transmission interface 241 and antenna 240 to enable the node to communicate using both wireline and wireless technologies. The various interfaces (wireless and wireline) are connected to a switch fabric 242 that operates under the control of the processor 230. A protocol stack 244 containing data and instructions configured to enable the node to participate in protocol exchanges on the network may optionally be included. Other conventional network element features, such as a packet queue 246 configured to temporarily store protocol data units for transmission on the network, may also be included. Additionally, the node may include a security module 148 containing an authentication module 250 configured to authenticate users, devices, or connections on the network, an authorization module 252 configured to determine appropriate authorization control information to prevent unauthorized access to the network, and an accounting module 254 configured to enable accounting entries to be established for communication sessions on the network. Other modules may be included as well and the invention is not limited to a particular implementation of the network device.

The functions described above may be implemented as a set of program instructions that are stored in a computer readable memory within the network element and executed on one or more processors within the network element. However, it will be apparent to a skilled person that all logic described herein can be embodied using discrete components, integrated circuitry such as an Application Specific Integrated Circuit (ASIC), programmable logic used in conjunction with a programmable logic device such as a Field Programmable Gate Array (FPGA) or microprocessor, a state machine, or any other device including any combination thereof. Programmable logic can be fixed temporarily or permanently in a tangible medium such as a read-only memory chip, a computer memory, a disk, or other storage medium. Programmable logic can also be fixed in a computer data signal embodied in a carrier wave, allowing the programmable logic to be transmitted over an interface such as a computer bus or communication network. All such embodiments are intended to fall within the scope of the present invention.

The invention is not limited to the embodiments described herein, which may be modified or varied without departing from the scope of the invention.

We claim:

1. A method of processing topology information at a node within a communication network, the network comprising a plurality of nodes interconnected by communication links, the node comprising a database of topology information relating to the network, the method comprising:
receiving a topology advertisement from another node of the network which provides information about a part of the network;
comparing a metric within the newly received topology advertisement which is related to aggregate distance or cost of the path travelled by the topology advertisement with the metric of a topology advertisement previously received for the same part of the network; and,
updating the database with the newly received topology advertisement if the value of the metric in the newly received topology advertisement is lower than the metric in the topology advertisement previously received for the same part of the network.

2. A method according to claim 1 wherein the comparing step comprises updating the metric in the newly received topology advertisement to include a value indicative of the distance or cost of the most recent portion of the path before comparing the metric of the newly received topology advertisement with one previously received.

3. A method according to claim 1 further comprising selectively forwarding the topology advertisement to another node if the metric is less than a predetermined value.

4. A method according to claim 3 further comprising acknowledging receipt of the topology advertisement, regardless of whether the topology advertisement is useful to the node.

5. A method according to claim 3 further comprising updating the value of the metric to include a value indicative of the distance or cost of the most recent portion of the path before forwarding the topology advertisement.

6. A method according to claim 1 further comprising an initial step of requesting a further copy of a topology advertisement which is already stored in the database.

7. A method according to claim 1 wherein the step of receiving a topology advertisement includes calculating a checksum on the contents of the topology advertisement which ignores the metric field, and comparing the checksum with a checksum value within the received topology advertisement.

8. A method according to claim 1 further comprising performing a calculation of a shortest path between nodes using information in the database, comparing a calculated shortest path with a metric in a stored topology advertisement received via that path and, if the calculated shortest path is less than the metric, forwarding a topology advertisement to another node which includes a metric representing the calculated shortest path.

9. A method according to claim 1 wherein the topology advertisement is a link state advertisement.

10. A node for use as part of a communication network, the network comprising a plurality of nodes interconnected by communication links, the node comprising a database of topology information relating to the network and control logic which is operable to:
receive a topology advertisement from another node of the network which provides information about a part of the network;
compare a metric within the newly received topology advertisement which is related to aggregate distance or cost of the path travelled by the topology advertisement with the metric of a topology advertisement previously received for the same part of the network; and,
update the database with the newly received topology advertisement if the value of the metric in the newly received topology advertisement is lower than the metric in the topology advertisement previously received for the same part of the network.

11. A node according to claim 10 wherein the control logic is further operable to update the metric in the newly received topology advertisement to include a value indicative of the distance or cost of the most recent portion of the path before comparing the metric of the newly received topology advertisement with one previously received.

12. A node according to claim 10 wherein the control logic is further operable to selectively forward the topology advertisement to another node if the metric is less than a predetermined value.

13. A node according to claim 12 wherein the control logic is further operable to acknowledge receipt of the topology advertisement, regardless of whether the topology advertisement is useful to the node.

14. A node according to claim 12 wherein the control logic is further operable to update the value of the metric to include a value indicative of the distance or cost of the most recent portion of the path before forwarding the topology advertisement.

15. A node according to claim 10 wherein the control logic is further operable to request a further copy of a topology advertisement which is already stored in the database.

16. A node according to claim 10 wherein the control logic is further operable to calculate a checksum on the contents of the topology advertisement which ignores the metric field, and compare the checksum with a checksum value within the received topology advertisement.

17. A node according to claim 10 wherein the control logic is further operable to perform a calculation of a shortest path between nodes using information in the database, compare a calculated shortest path with a metric in a stored topology advertisement received via that path and, if the calculated shortest path is less than the metric, forward a topology advertisement to another node which includes a metric representing the calculated shortest path.

18. A node according to claim 10 wherein the topology advertisement is a link state advertisement.

19. A communication network including at least one node according to claim 10.

20. A computer program product comprising a machine readable medium carrying instructions for controlling a node of a communication network, the network comprising a plurality of nodes interconnected by communication links, the node comprising a database of topology information relating to the network, the instructions causing the node to:
receive a topology advertisement from another node of the network which provides information about a part of the network;
compare a metric within the newly received topology advertisement which is related to aggregate distance or cost of the path travelled by the topology advertisement with the metric of a topology advertisement previously received for the same part of the network; and,
update the database with the newly received topology advertisement if the value of the metric in the newly received topology advertisement is lower than the metric in the topology advertisement previously received for the same part of the network.

21. A signal for transmission across a communication network which carries a topology advertisement message, the message comprising a header and a body and wherein a metric indicative of the distance travelled by the message is included within the header.

22. A signal for transmission across a communication network which carries a topology advertisement message, the message comprising a header and a body and wherein a metric indicative of the distance travelled by the message is included within the body.

23. A signal according to claim 22 wherein the topology advertisement is a link state advertisement.

24. A signal according to claim 23 wherein the link state advertisement is an Open Shortest Path First (OSPF) Link State Advertisement (LSA), the body of the message comprises a flags field and the metric is positioned within the flags field.

25. A signal according to claim 24 wherein the metric is positioned within the unused 13 bits of the flags field.
